(19) United States
(12) Patent Application Publication
(10) Pub. No.: US 2026/0304434 A1
(43) Pub. Date: Oct. 1, 2026

(54) HYBRID AUTOMATIC REPEAT REQUEST CODEBOOK FOR CROSS RADIO ACCESS TECHNOLOGY

(71) Applicant: QUALCOMM Incorporated, San Diego, CA (US)

(72) Inventors: Jing DAI, Beijing (CN); Kianoush HOSSEINI, San Diego, CA (US); Kangqi LIU, San Diego, CA (US)

(21) Appl. No.: 19/479,903

(22) PCT Filed: Jun. 25, 2023
(86) PCT No.: PCT/CN2023/102042

§ 371 Date: Oct. 29, 2025

(51) Int. Cl. H04W 72/23; H04L 1/1829

(52) U.S. Cl. CPC H04W 72/23; H04L 1/1864

(57) ABSTRACT

Various aspects of the present disclosure generally relate to wireless communication. In some aspects, a user equipment (UE) may receive a cross radio access technology (cross-RAT) indication for joint or separate downlink assignment index (DAI) fields via downlink control information (DCI) for a hybrid automatic repeat request (HARQ) codebook. The UE may monitor a physical downlink control channel (PDCCH) across multiple component carriers in accordance with the cross-RAT indication for the joint or separate DAI fields. Numerous other aspects are described.

### FIELD OF THE DISCLOSURE

Aspects of the present disclosure generally relate to wireless communication and to techniques and apparatuses for a hybrid automatic repeat request codebook for cross radio access technology.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a cross radio access technology (cross-RAT) indication for joint or separate downlink assignment index (DAI) fields via downlink control information (DCI) for a hybrid automatic repeat request (HARQ) codebook. The method may include monitoring a physical downlink control channel (PDCCH) across multiple component carriers in accordance with the cross-RAT indication for the joint or separate DAI fields.

Some aspects described herein relate to a method of wireless communication performed by a UE. The method may include receiving a configuration for a first semi-static HARQ codebook associated with a first RAT and a second semi-static HARQ codebook associated with a second RAT. The method may include monitoring a PDCCH across multiple component carriers in accordance with the first semi-static HARQ codebook and the second semi-static HARQ codebook.

Some aspects described herein relate to a method of wireless communication performed by a network node. The method may include transmitting a cross-RAT indication for joint or separate DAI fields via DCI for a HARQ codebook. The method may include configuring a UE to monitor a PDCCH across multiple component carriers in accordance with the cross-RAT indication for the joint or separate DAI fields.

Some aspects described herein relate to a method of wireless communication performed by a network node. The method may include transmitting a configuration for a first semi-static HARQ codebook associated with a first RAT and a second semi-static HARQ codebook associated with a second RAT. The method may include configuring a UE to monitor a PDCCH across multiple component carriers in accordance with the first semi-static HARQ codebook and the second semi-static HARQ codebook.

Some aspects described herein relate to an apparatus for wireless communication at a UE. The apparatus may include one or more memories and one or more processors. The one or more processors, individually or collectively and based at least in part on information stored in the one or more memories, may be configured to receive a cross-RAT indication for joint or separate DAI fields via DCI for a HARQ codebook. The one or more processors may be configured to monitor a PDCCH across multiple component carriers in accordance with the cross-RAT indication for the joint or separate DAI fields.

Some aspects described herein relate to an apparatus for wireless communication at a UE. The apparatus may include one or more memories and one or more processors. The one or more processors, individually or collectively and based at least in part on information stored in the one or more memories, may be configured to receive a configuration for a first semi-static HARQ codebook associated with a first RAT and a second semi-static HARQ codebook associated with a second RAT. The one or more processors may be configured to monitor a PDCCH across multiple component carriers in accordance with the first semi-static HARQ codebook and the second semi-static HARQ codebook.

Some aspects described herein relate to an apparatus for wireless communication at a network node. The apparatus may include one or more memories and one or more processors. The one or more processors, individually or collectively and based at least in part on information stored in the one or more memories, may be configured to transmit a cross-RAT indication for joint or separate DAI fields via DCI for a HARQ codebook. The one or more processors may be configured to configure a UE to monitor a PDCCH across multiple component carriers in accordance with the cross-RAT indication for the joint or separate DAI fields.

Some aspects described herein relate to an apparatus for wireless communication at a network node. The apparatus may include one or more memories and one or more processors. The one or more processors, individually or collectively and based at least in part on information stored in the one or more memories, may be configured to transmit a configuration for a first semi-static HARQ codebook associated with a first RAT and a second semi-static HARQ codebook associated with a second RAT. The one or more processors may be configured to configure a UE to monitor a PDCCH across multiple component carriers in accordance with the first semi-static HARQ codebook and the second semi-static HARQ codebook.

Some aspects described herein relate to a non-transitory computer-readable medium storing a set of instructions for wireless communication by a UE. The set of instructions, when executed by one or more processors of the UE, may cause the UE to receive a cross-RAT indication for joint or separate DAI fields via DCI for a HARQ codebook. The set of instructions, when executed by one or more processors of the UE, may cause the UE to monitor a PDCCH across multiple component carriers in accordance with the cross-RAT indication for the joint or separate DAI fields.

Some aspects described herein relate to a non-transitory computer-readable medium storing a set of instructions for wireless communication. The instructions, when executed by one or more processors of a UE, may cause the UE to receive a configuration for a first semi-static HARQ codebook associated with a first RAT and a second semi-static HARQ codebook associated with a second RAT. The set of instructions, when executed by one or more processors of an UE, may cause the UE to monitor a PDCCH across multiple component carriers in accordance with the first semi-static HARQ codebook and the second semi-static HARQ codebook.

Some aspects described herein relate to a non-transitory computer-readable medium storing a set of instructions for wireless communication by a network node. The set of instructions, when executed by one or more processors of the network node, may cause the network node to transmit a cross-RAT indication for joint or separate DAI fields via DCI for a HARQ codebook. The set of instructions, when executed by one or more processors of the network node, may cause the network node to configure a UE to monitor a PDCCH across multiple component carriers in accordance with the cross-RAT indication for the joint or separate DAI fields.

Some aspects described herein relate to a non-transitory computer-readable medium storing a set of instructions for wireless communication by a network node. The set of instructions, when executed by one or more processors of the network node, may cause the network node to transmit a configuration for a first semi-static HARQ codebook associated with a first RAT and a second semi-static HARQ codebook associated with a second RAT. The set of instructions, when executed by one or more processors of the network node, may cause the network node to configure a UE to monitor a PDCCH across multiple component carriers in accordance with the first semi-static HARQ codebook and the second semi-static HARQ codebook.

Some aspects described herein relate to an apparatus for wireless communication. The apparatus may include means for receiving a cross-RAT indication for joint or separate DAI fields via DCI for a HARQ codebook. The apparatus may include means for monitoring a PDCCH across multiple component carriers in accordance with the cross-RAT indication for the joint or separate DAI fields.

Some aspects described herein relate to an apparatus for wireless communication. The apparatus may include means for receiving a configuration for a first semi-static HARQ codebook associated with a first RAT and a second semi-static HARQ codebook associated with a second RAT. The apparatus may include means for monitoring a PDCCH across multiple component carriers in accordance with the first semi-static HARQ codebook and the second semi-static HARQ codebook.

Some aspects described herein relate to an apparatus for wireless communication. The apparatus may include means for transmitting a cross-RAT indication for joint or separate DAI fields via DCI for a HARQ codebook. The apparatus may include means for configuring a UE to monitor a PDCCH across multiple component carriers in accordance with the cross-RAT indication for the joint or separate DAI fields.

Some aspects described herein relate to an apparatus for wireless communication. The apparatus may include means for transmitting a configuration for a first semi-static HARQ codebook associated with a first RAT and a second semi-static HARQ codebook associated with a second RAT. The apparatus may include means for configuring a UE to monitor a PDCCH across multiple component carriers in accordance with the first semi-static HARQ codebook and the second semi-static HARQ codebook.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIGS. 5A-5B are diagrams illustrating examples associated with hybrid automatic repeat request (HARQ) codebooks for cross radio access technology (cross-RAT) communications, in accordance with the present disclosure.

FIG. 6 is a diagram illustrating an example associated with semi-static HARQ codebooks for cross-RAT communications, in accordance with the present disclosure.

FIG. 7 is a diagram illustrating an example process performed, for example, by a UE, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Hybrid automatic repeat request (HARQ) is a protocol used to provide reliable data transmission over a radio access network (RAN). For example, the HARQ protocol allows a device, such as a user equipment (UE) or network node (such as a gNodeB (gNB)) to retransmit lost or corrupted packets to increase the likelihood of a successful delivery. HARQ codebooks include codewords utilized by both a transmitter and a receiver within a RAN for data distinction and error mitigation. The codewords facilitate the differentiation between various data types and additionally serve as tools for error detection and correction. In the event of data corruption or loss during transmission, the codewords contained within the HARQ codebook can be employed to either correct the error or instigate a retransmission request, thereby enhancing the robustness of data delivery.

Different radio access technologies (RATs) may use different HARQ codebooks that, for example, reflect unique characteristics, design objectives, and target environments associated with each RAT. The HARQ codebook associated with a RAT may be based on factors such as network topology, physical layer characteristics, specific service requirements of each technology, and/or a combination thereof, among other examples.

Various aspects relate generally to facilitating wireless communications over multiple RATs. Some aspects more specifically relate to configuring HARQ codebooks to be used for communications over multiple RATs. In some examples, a UE receives a cross-RAT indication for joint or separate downlink assignment index (DAI) fields via downlink control information (DCI) for a HARQ codebook, and monitors a physical downlink control channel (PDCCH) across multiple component carriers in accordance with the cross-RAT indication for the joint or separate DAI fields. Alternatively or in addition, in some examples, the UE receives a configuration for a first semi-static HARQ codebook associated with a first RAT and a second semi-static HARQ codebook associated with a second RAT, and monitors a PDCCH across multiple component carriers in accordance with the first semi-static HARQ codebook and the second semi-static HARQ codebook. In some examples, a network node transmits a cross-RAT indication for joint or separate DAI fields via DCI for a HARQ codebook, and configures a UE to monitor a PDCCH across multiple component carriers in accordance with the cross-RAT indication for the joint or separate DAI fields. Alternatively or in addition, in some examples, the network node transmits a configuration for a first semi-static HARQ codebook associated with a first RAT and a second semi-static HARQ codebook associated with a second RAT, and configures a UE to monitor a PDCCH across multiple component carriers in accordance with the first semi-static HARQ codebook and the second semi-static HARQ codebook.

Particular aspects of the subject matter described in this disclosure can be implemented to realize one or more of the following potential advantages. In some examples, by monitoring a PDCCH across multiple component carriers in accordance with the cross-RAT indication for the joint or separate DAI fields or in accordance with the first semi-static HARQ codebook and the second semi-static HARQ codebook, the described techniques can be used to facilitate inter-band carrier aggregation over multiple RATs, thereby allowing the UE to communicate over multiple RANs. In some examples, by transmitting a cross-RAT indication for joint or separate DAI fields via DCI for a HARQ codebook or by transmitting a configuration for a first semi-static HARQ codebook associated with a first RAT and a second semi-static HARQ codebook associated with a second RAT, the described techniques can be used to configure a UE to prioritize monitoring occasions when communicating over multiple RANs.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) RAT, aspects of the present disclosure can be applied to other RATs, such as a 3G RAT, a 4G RAT, and/or a RAT subsequent to 5G (e.g., 6G).

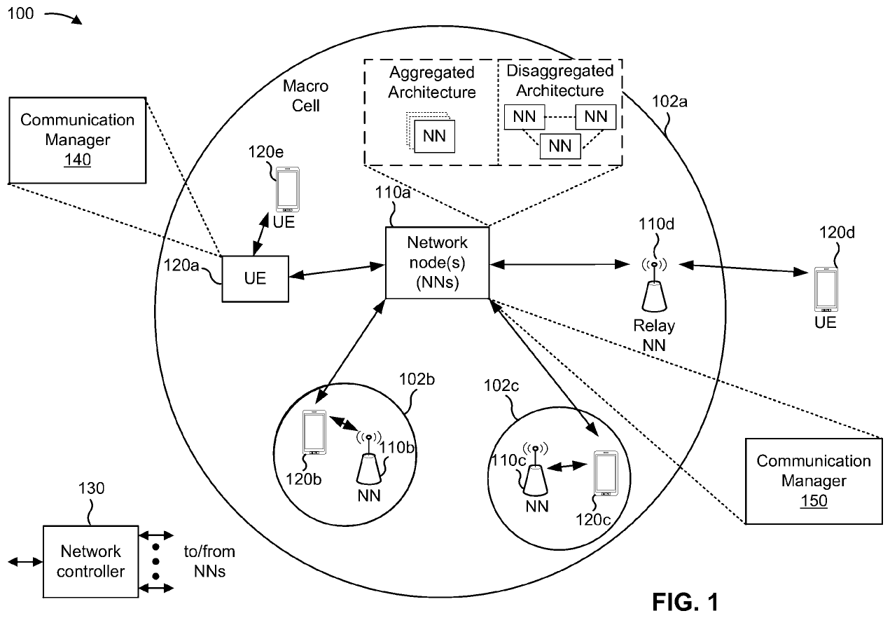

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a cross-RAT indication for joint or separate DAI fields via DCI for a HARQ codebook; and monitor a PDCCH across multiple component carriers in accordance with the cross-RAT indication for the joint or separate DAI fields.

In some aspects, as described in more detail elsewhere herein, the communication manager 140 may receive a configuration for a first semi-static HARQ codebook associated with a first RAT and a second semi-static HARQ codebook associated with a second RAT; and monitor a PDCCH across multiple component carriers in accordance with the first semi-static HARQ codebook and the second semi-static HARQ codebook. Additionally, or alternatively, the communication manager 140 may perform one or more other operations described herein.

In some aspects, the network node 110 may include a communication manager 150. As described in more detail elsewhere herein, the communication manager 150 may transmit a cross-RAT indication for joint or separate DAI fields via DCI for a HARQ codebook; and configure a UE to monitor a PDCCH across multiple component carriers in accordance with the cross-RAT indication for the joint or separate DAI fields.

In some aspects, as described in more detail elsewhere herein, the communication manager 150 may transmit a configuration for a first semi-static HARQ codebook associated with a first RAT and a second semi-static HARQ codebook associated with a second RAT; and configure a UE to monitor a PDCCH across multiple component carriers in accordance with the first semi-static HARQ codebook and the second semi-static HARQ codebook. Additionally, or alternatively, the communication manager 150 may perform one or more other operations described herein.

As indicated above, FIG. 1 is provided as an example. Other examples may differ from what is described with regard to FIG. 1.

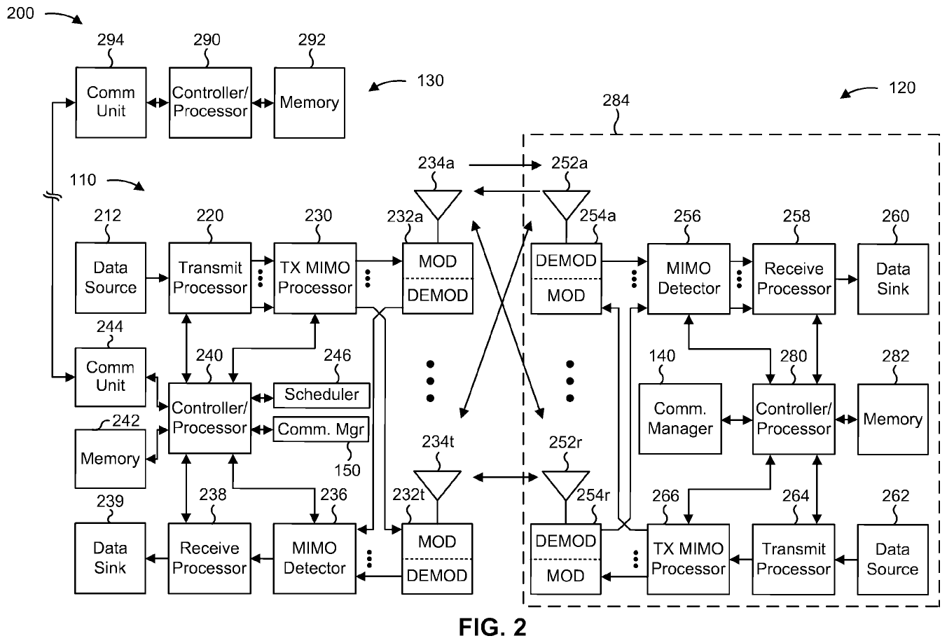

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

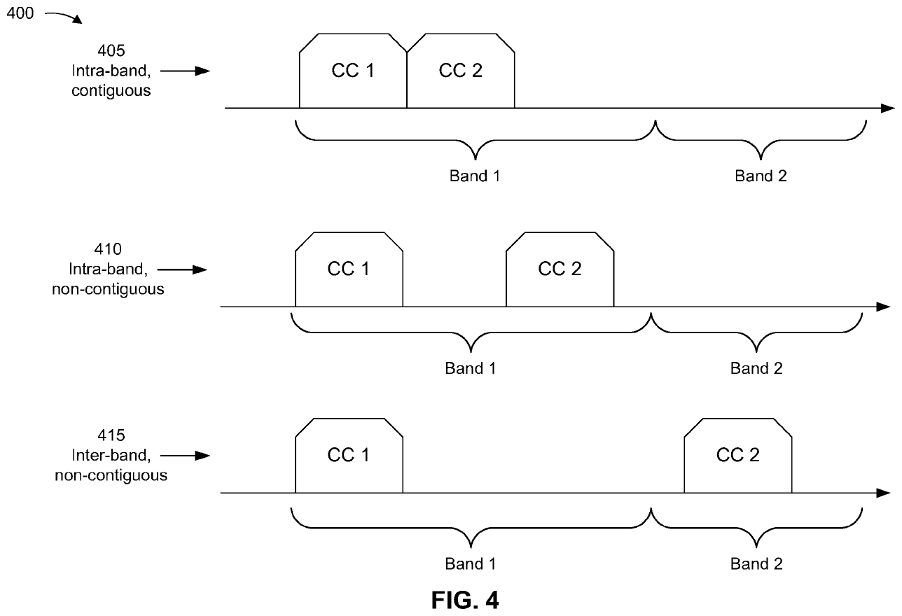

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

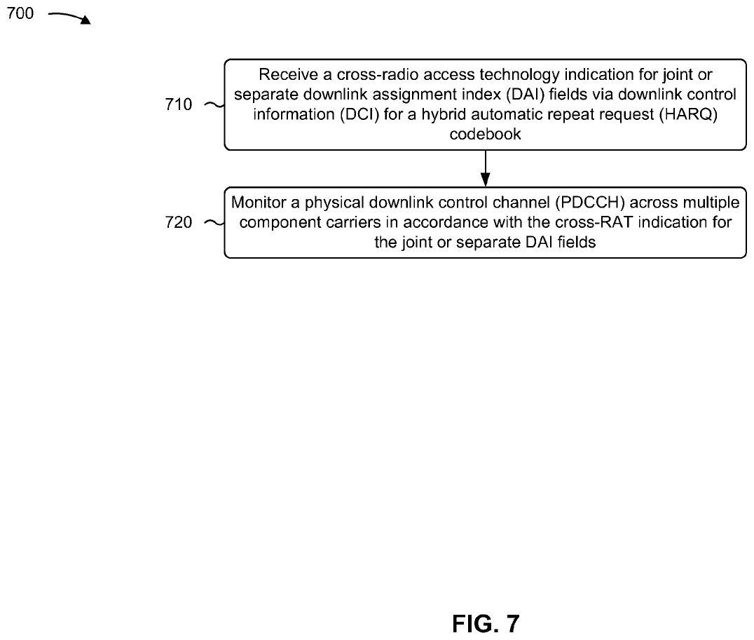

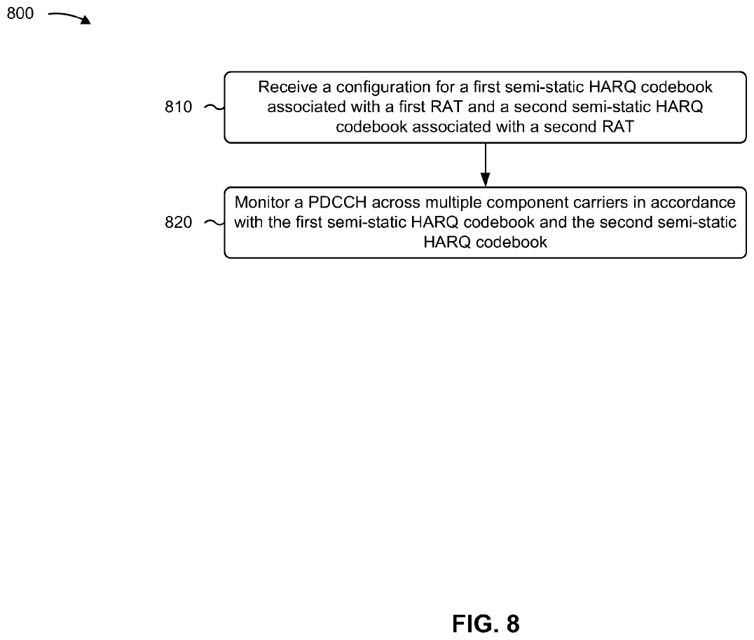

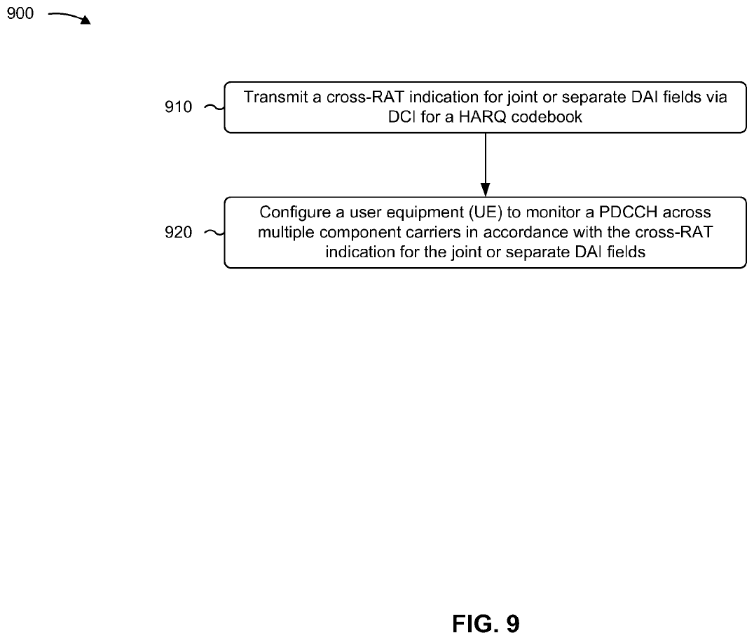

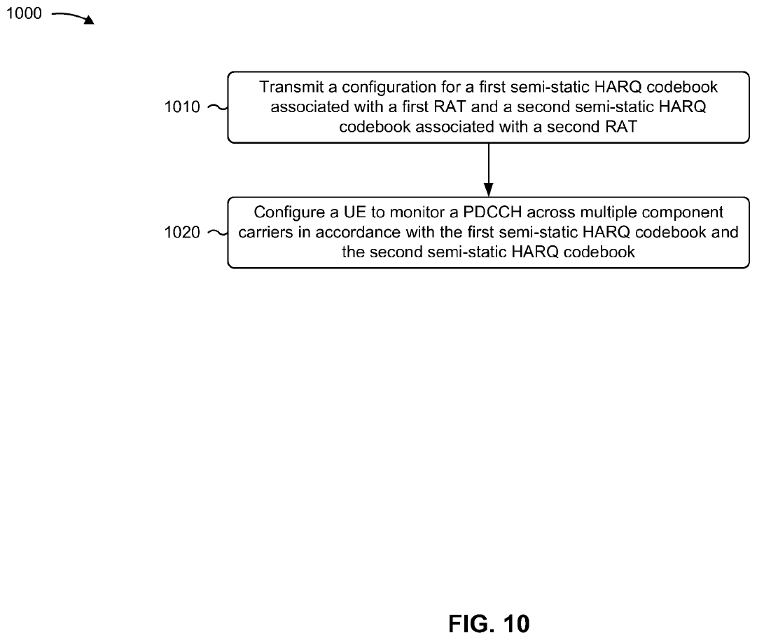

The controller/processor 240 of the network node 110, the controller/processor 280 of the UE 120, and/or any other component(s) of FIG. 2 may perform one or more techniques associated with HARQ codebooks for cross-RAT communications, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a cross-RAT indication for joint or separate DAI fields via DCI for a HARQ codebook; and/or means for monitoring a PDCCH across multiple component carriers in accordance with the cross-RAT indication for the joint or separate DAI fields. In some aspects, the UE 120 includes means for receiving a configuration for a first semi-static HARQ codebook associated with a first RAT and a second semi-static HARQ codebook associated with a second RAT; and/or means for monitoring a PDCCH across multiple component carriers in accordance with the first semi-static HARQ codebook and the second semi-static HARQ codebook. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a cross-RAT indication for joint or separate DAI fields via DCI for a HARQ codebook; and/or means for configuring a UE to monitor a PDCCH across multiple component carriers in accordance with the cross-RAT indication for the joint or separate DAI fields. In some aspects, the network node 110 includes means for transmitting a configuration for a first semi-static HARQ codebook associated with a first RAT and a second semi-static HARQ codebook associated with a second RAT; and/or means for configuring a UE to monitor a PDCCH across multiple component carriers in accordance with the first semi-static HARQ codebook and the second semi-static HARQ codebook. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

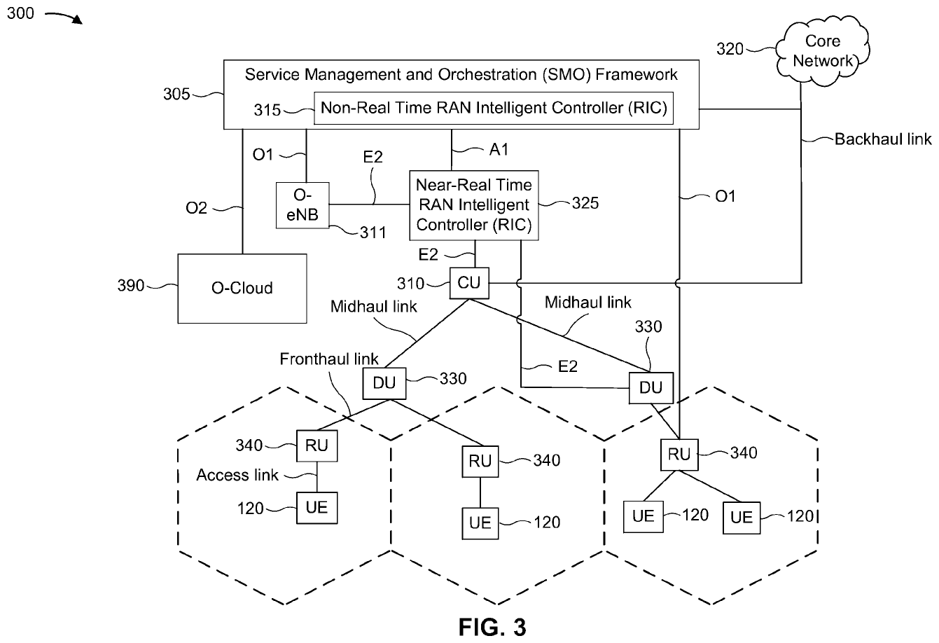

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400 of carrier aggregation, in accordance with the present disclosure.

A low-band anchor may be used to facilitate the transition between RANs using different RATs. The low-band anchor may be carried out via carrier aggregation. Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in a radio resource control (RRC) message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

Carrier aggregation may be used to provide the low-band anchor. For example, inter-band carrier aggregation may combine a low-band frequency, which may be used as an anchor band to provide network stability, with higher band frequencies, which may be used to improve network performance, when transitioning between RANs using multi-RAT spectrum sharing (MRSS). One way to implement inter-band carrier aggregation is for component carriers of both RANs to share a same frequency band. Additionally, joint MAC scheduling across RATs may allow the RANs to provide cross-RAT carrier aggregation. Alternatively, the low-band anchor may be provided via a supplementary uplink from, for example, one of the RANs or a virtual downlink carrier.

As indicated above, FIG. 4 is provided as an example. Other examples may differ from what is described with regard to FIG. 4.

In the context of cross-RAT carrier aggregation between multiple RANs, uplink control can be facilitated by a HARQ codebook for the physical downlink shared channel (PDSCH). As discussed above, HARQ allows a UE 120 and network node 110 to facilitate error correction. When data is transmitted between the UE 120 and network node 110, the data may get corrupted due to, for example, interference or poor signal strength. HARQ helps in correcting these errors and increasing the likelihood that the data is received correctly. The HARQ codebook for the PDSCH may include a predefined set of information that helps the UE 120 and network node 110 correct errors in received data.

“Uplink control” may refer to the process of sending uplink control information (UCI) from the UE 120 to the network node 110. UCI may include an acknowledgement (ACK) that data has been received correctly or a negative acknowledgement (NACK) indicating that there were errors in the received data (which may trigger retransmission through the HARQ process). When the network node 110 sends data to the UE 120 over the PDSCH, the UE 120 may use the HARQ codebook to check for errors in the received data. If errors are detected, the UE 120 may send the NACK to the network node 110 via a physical uplink control channel (PUCCH), signaling that the data needs to be resent. If the data is received correctly, the UE 120 may send the ACK.

Cross-RAT scheduling is a technique where certain communications between the UE 120 and the network node 110 are scheduled to occur via different RATs. For example, with cross-RAT scheduling, PDCCH communications via one RAT may be used to schedule PDSCH communications via a different RAT.

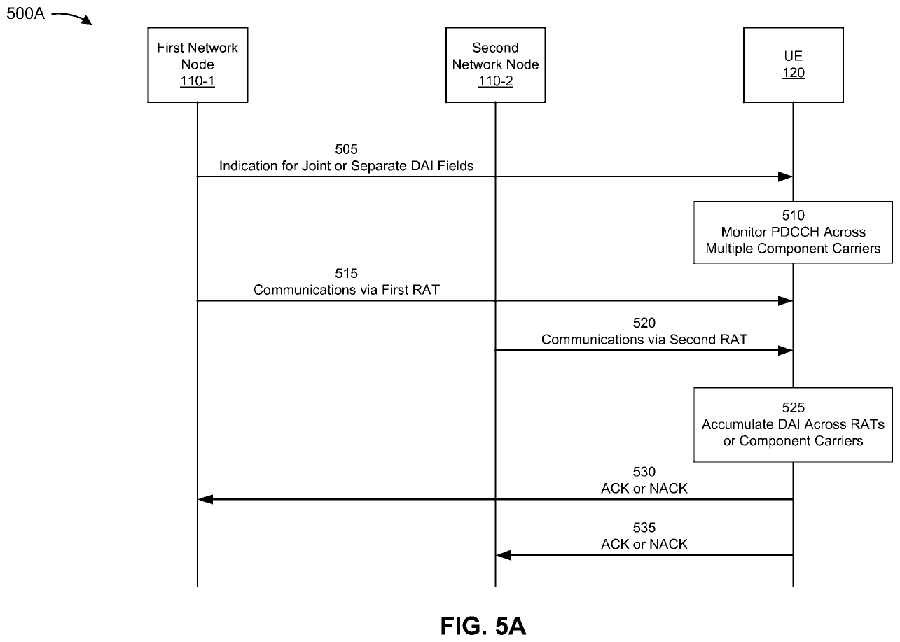

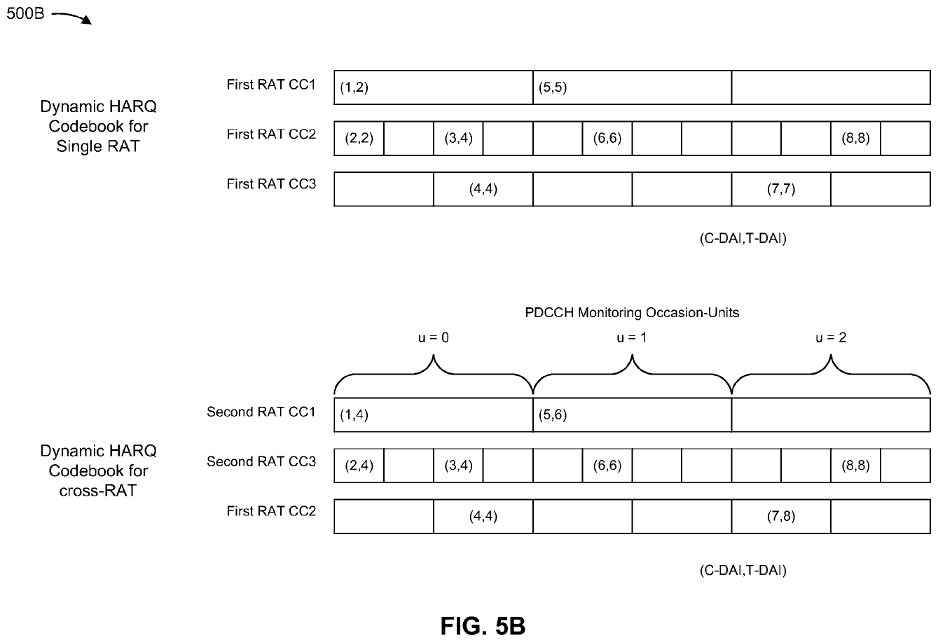

FIG. 5A is a diagram illustrating an example 500A associated with HARQ codebooks for cross-RAT communications, in accordance with the present disclosure. As shown in FIG. 5A, a first network node 110-1, a second network node 110-2, and a UE 120 may communicate with one another. The first network node 110-1 may be associated with a first RAN communicating via a first RAT and the second network node 110-2 may be associated with a second RAN communicating via a second RAT. The UE 120 may be configured to communicate with both the first RAN and the second RAN via the first RAT and the second RAT, respectively.

As shown by reference number 505, the first network node 110-1 may transmit, and the UE 120 may receive, a cross-RAT indication for joint or separate DAI fields. DAI may be used to track the transmission of downlink communications over a set of subframes. The DAI may be encoded in the DCI and may indicate the number of downlink data transmissions that a UE (such as UE 120) has received within a transmission time interval. As it relates to HARQ, the DAI fields may be used by the UE 120 to correlate received transmissions with corresponding HARQ processes. For instance, upon transmission of a data packet, the network node (such as the first network node 110-1 and/or the second network node 110-2) may assign the packet a DAI which is then communicated to the UE 120. The UE 120 may use the received DAI to identify the HARQ process associated with the transmitted packet, which allows the UE 120 to send an appropriate acknowledgement (ACK) or negative acknowledgement (NACK) signal back to the transmitting network node, as discussed in greater detail below. The application of DAI fields to HARQ processes may be defined by one or more HARQ codebooks.

The DAI may be a 4-bit value. The two most significant bits of the DAI may represent a counter DAI (C-DAI) value and the two least significant bits of the DAI may represent the total DAI (T-DAI) value. The C-DAI value may be used to track the number of downlink assignments for a specific HARQ process while the T-DAI value may indicate the total number of downlink assignments that have occurred.

As discussed in greater detail below, the DAI fields may be joint or separate for cross-RAT communications. For example, “joint DAI fields” may refer to situations where the same DAI fields, and thus the same C-DAI value and T-DAI value, may be used for communications from the first network node 110-1 via the first RAT and the second network node 110-2 via the second RAT. “Separate DAI fields” may refer to situations where different DAI fields apply to each RAT. For example, a first DAI field may apply to communications from the first network node 110-1 via the first RAT, and a second DAI field may apply to communications from the second network node 110-2 via the second RAT. In some instances, such as when multiple component carriers have different subcarrier spacings, each of the joint or separate DAI fields includes a T-DAI value.

As shown by reference number 510, the UE 120 may monitor the PDCCH across multiple component carriers, such as component carriers associated with the first network node 110-1 and the second network node 110-2, among other examples, in accordance with the cross-RAT indication.

In some aspects, the cross-RAT indication may be for separate DAI fields. In some aspects, the separate DAI fields may be each associated with PDCCH communications via different RATs. In some aspects, the separate DAI fields may be each associated with PDSCH communications via different RATs. In some aspects, the separate DAI fields may include C-DAI values. In some aspects, only one of the C-DAI values may be indicated via the DCI. In some aspects, the separate DAI fields may include T-DAI values, in which case the cross-RAT indication may include one or more indications for T-DAI values associated with both scheduled and non-scheduled RAT communications. Alternatively, the cross-RAT indication may include an indication for T-DAI values associated with non-scheduled RAT communications. In another alternative, the cross-RAT indication may include an indication for T-DAI values associated with scheduled RAT communications.

In some aspects, the cross-RAT indication may be for a joint DAI field. In situations where the cross-RAT indication is for a joint DAI field, the UE 120 may monitor a PDCCH of two component carriers having a same RAT before monitoring a PDCCH of one or more component carriers having a different RAT. Alternatively, the UE 120 may monitor a PDCCH of one or more component carriers in order of a component carrier index.

As shown by reference number 515, the first network node 110-1 may transmit, and the UE 120 may receive, a downlink communication via the first RAT. The downlink communication via the first RAT may be transmitted via a first component carrier.

As shown by reference number 520, the second network node 110-2 may transmit, and the UE 120 may receive, a downlink communication via the second RAT. The communication via the second RAT may be transmitted via a second component carrier.

As shown by reference number 525, the UE 120 may accumulate a T-DAI value across one or more of the first RAT and the second RAT or across component carriers. In some aspects, accumulating the T-DAI value may include accumulating a total number of component carrier pairs or PDCCH occasion pairs up to a current PDCCH occasion unit. The current PDCCH occasion unit may be based, at least in part, on an active bandwidth part and subcarrier spacing associated with one of the component carriers. The current PDCCH occasion unit may be anchored on a PDCCH search space associated with a downlink scheduling DCI format. For example, a size of the PDCCH occasion unit may be based, at least in part, on the periodicity of the PDCCH search space, the number of slots in the PDCCH search space, and/or a combination thereof, among other examples, such as the example 500B shown in FIG. 5B.

As shown by reference number 530, the UE 120 may transmit, and the first network node 110-1 may receive, a response to the communication via the first RAT. The response may include, for example, an ACK or NACK signal indicating whether the communication via the first RAT was properly received and decoded by the UE 120.

As shown by reference number 535, the UE 120 may transmit, and the second network node 110-2 may receive, a response to the communication via the second RAT. The response may include, for example, an ACK or NACK signal indicating whether the communication via the second RAT was properly received and decoded by the UE 120.

With reference to example 500B shown in FIG. 5B, accumulating C-DAI and T-DAI may be different when a dynamic HARQ codebook is applied to single RAT communications (e.g., communications via the first RAT, which may be 5G NR) with different subcarrier spacings and when the dynamic HARQ codebook is applied to cross-RAT communications (which may be 5G NR as the first RAT, and 6G as the second RAT) with different subcarrier spacings.

For single RAT communications, T-DAI may be accumulated in order of component carriers. In this situation, an occasion for T-DAI is defined by starting symbol of PDCCH monitoring occasion (e.g., in the upper figure of FIG. 5B, the occasion labeled as (1,2) for CC1 and the occasion labeled as (2,2) for CC2 have a same T-DAI value of 2, while the occasion labeled as (3,4) for CC2 and the occasion labeled as (4,4) for CC3 have a same T-DAI value of 4), which may reduce the usefulness of the accumulated T-DAI value. For cross-RAT communications, T-DAI may be accumulated based, at least in part, on the total number of component carriers, PDCCH occasions, or pairs of component carriers and PDCCH occasions groups by RATs. In the example 500B, C-DAI and T-DAI for component carriers associated with the second RAT (i.e., CC1 and CC3) are accumulated before the component carrier associated with the first RAT (i.e., CC2).

Moreover, in the example 500B, T-DAI for the component carrier and PDCCH occasion pairs is accumulated up to a current PDCCH occasion unit u. The unit u may be defined based, at least in part, on one particular component carrier, such as a component carrier anchored on an active BWP (e.g., the active BWP of CC1 in the lower figure of FIG. 5B) with a certain subcarrier spacing. The unit u may also be anchored on a PDCCH search space with a downlink scheduling DCI format. For example, in the lower figure of FIG. 5B, the occasions labeled as (1,4) for CC1, (2,4) for CC3, (3,4) for CC3, and (4,4) for CC2 have a same T-DAI value of 4. In this example, T-DAI's unit u may be anchored on the active BWP of CC1 with the largest subcarrier spacing amongst the component carriers CC1, CC3, and CC2.

As indicated above, FIGS. 5A-5B are provided as examples. Other examples may differ from what is described with respect to FIGS. 5A-5B.

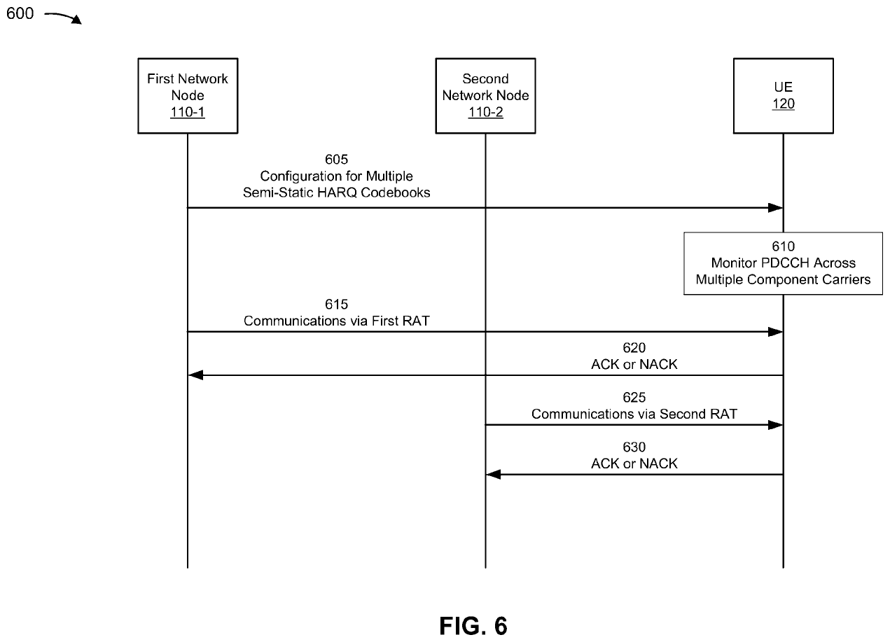

FIG. 6 is a diagram illustrating an example 600 associated with semi-static HARQ codebooks for cross-RAT communications, in accordance with the present disclosure. As shown in FIG. 6, a first network node 110-1, a second network node 110-2, and a UE 120 may communicate with one another. The first network node 110-1 may be associated with a first RAN communicating via a first RAT and the second network node 110-2 may be associated with a second RAN communicating via a second RAT. The UE 120 may be configured to communicate with both the first RAN and the second RAN via the first RAT and the second RAT, respectively.

As shown by reference number 605, the first network node 110-1 may transmit, and the UE 120 may receive, a configuration for a first semi-static HARQ codebook associated with the first RAT and a second semi-static HARQ codebook associated with the second RAT. In some aspects, the first semi-static HARQ codebook may be associated with a PDCCH of the first RAT and the second semi-static HARQ codebook may be associated with a PDCCH of the second RAT. In some aspects, the first semi-static HARQ codebook may include HARQ ACK or NACK bits for PDSCH communications associated with the first RAT and the second semi-static HARQ codebook may include HARQ ACK or NACK bits for PDSCH communications associated with the first RAT and the second RAT. In some aspects, the first semi-static HARQ codebook includes HARQ ACK or NACK bits for PDSCH communications associated with the first RAT and the second RAT and the second semi-static HARQ codebook includes HARQ ACK or NACK bits for PDSCH communications associated with the second RAT.

As shown by reference number 610, the UE 120 may monitor a PDCCH across multiple component carriers in accordance with the first semi-static HARQ codebook and the second semi-static HARQ codebook. In some aspects, monitoring the PDCCH across multiple component carriers may include monitoring a PDCCH based, at least in part, on a component carrier and RAT (e.g., the first RAT or the second RAT) associated with one of the first semi-static HARQ codebook or the second semi-static HARQ codebook. In some aspects, monitoring the PDCCH across multiple component carriers may include monitoring the PDCCH based, at least in part, on a component carrier index. For example, the PDCCH of component carriers with a lower component carrier index may be monitored before the PDCCH of component carriers with a higher component carrier index.

As shown by reference number 615, the first network node 110-1 may transmit, and the UE 120 may receive, a downlink communication via the first RAT. The downlink communication via the first RAT may be transmitted via a first component carrier.

As shown by reference number 620, the UE 120 may transmit, and the first network node 110-1 may receive, a response to the communication via the first RAT. The response may include, for example, an ACK or NACK signal indicating whether the communication via the first RAT was properly received and decoded by the UE 120.

As shown by reference number 625, the second network node 110-2 may transmit, and the UE 120 may receive, a downlink communication via the second RAT. The communication via the second RAT may be transmitted via a second component carrier.

As shown by reference number 630, the UE 120 may transmit, and the second network node 110-2 may receive, a response to the communication via the second RAT. The response may include, for example, an ACK or NACK signal indicating whether the communication via the second RAT was properly received and decoded by the UE 120.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with HARQ codebooks for cross-RAT communications.

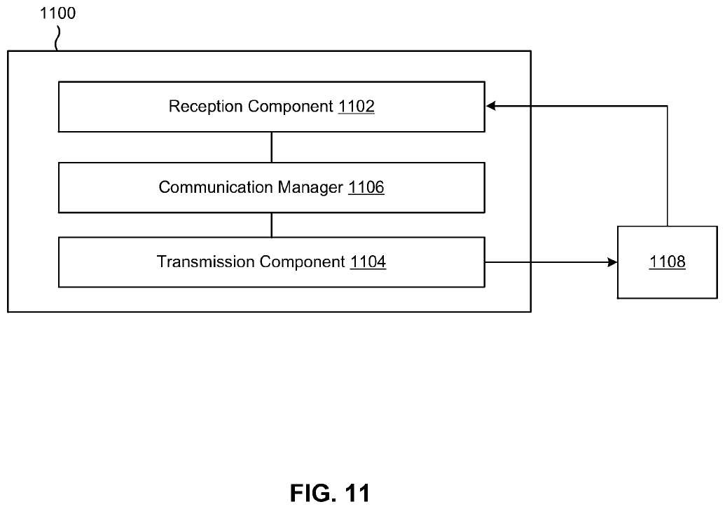

As shown in FIG. 7, in some aspects, process 700 may include receiving a cross-RAT indication for joint or separate DAI fields via DCI for a HARQ codebook (block 710). For example, the UE (e.g., using reception component 1102 and/or communication manager 1106, depicted in FIG. 11) may receive a cross-RAT indication for joint or separate DAI fields via DCI for a HARQ codebook, as described above.

As further shown in FIG. 7, in some aspects, process 700 may include monitoring a PDCCH across multiple component carriers in accordance with the cross-RAT indication for the joint or separate DAI fields (block 720). For example, the UE (e.g., using communication manager 1106, depicted in FIG. 11) may monitor a PDCCH across multiple component carriers in accordance with the cross-RAT indication for the joint or separate DAI fields, as described above.

Process 700 may include additional aspects, such as any single aspect or any combination of aspects described below and/or in connection with one or more other processes described elsewhere herein.

In a first aspect, the cross-RAT indication is for separate DAI fields.

In a second aspect, alone or in combination with the first aspect, the separate DAI fields are each associated with PDCCH communications via different radio access technologies.

In a third aspect, alone or in combination with one or more of the first and second aspects, the separate DAI fields are each associated with PDSCH communications via different radio access technologies.

In a fourth aspect, alone or in combination with one or more of the first through third aspects, the separate DAI fields include C-DAI values, and only one of the C-DAI values is indicated via the DCI.

In a fifth aspect, alone or in combination with one or more of the first through fourth aspects, the separate DAI fields include T-DAI values.

In a sixth aspect, alone or in combination with one or more of the first through fifth aspects, the cross-RAT indication for the separate DAI fields includes one or more indications for T-DAI values associated with both scheduled and non-scheduled radio access technology communications.

In a seventh aspect, alone or in combination with one or more of the first through sixth aspects, the cross-RAT indication for the separate DAI fields includes an indication for T-DAI values associated with non-scheduled radio access technology communications.

In an eighth aspect, alone or in combination with one or more of the first through seventh aspects, the cross-RAT indication for the separate DAI fields includes an indication for T-DAI values associated with scheduled radio access technology communications.

In a ninth aspect, alone or in combination with one or more of the first through eighth aspects, the cross-RAT indication is for a joint DAI field.

In a tenth aspect, alone or in combination with one or more of the first through ninth aspects, monitoring the PDCCH across multiple component carriers includes monitoring a PDCCH of two or more component carriers having a same radio access technology before monitoring a PDCCH of one or more component carriers having a different radio access technology.

In an eleventh aspect, alone or in combination with one or more of the first through tenth aspects, monitoring the PDCCH across the multiple component carriers includes monitoring a PDCCH of one or more component carriers in order of a component carrier index.

In a twelfth aspect, alone or in combination with one or more of the first through eleventh aspects, the multiple component carriers have different subcarrier spacings, and each of the joint or separate DAI fields includes a T-DAI value.

In a thirteenth aspect, alone or in combination with one or more of the first through twelfth aspects, process 700 includes accumulating a T-DAI value across one or more of radio access technologies or component carriers.

In a fourteenth aspect, alone or in combination with one or more of the first through thirteenth aspects, accumulating the T-DAI value includes accumulating a total number of component carrier pairs or PDCCH occasion pairs up to a current PDCCH occasion unit.

In a fifteenth aspect, alone or in combination with one or more of the first through fourteenth aspects, the current PDCCH occasion unit is based, at least in part, on an active bandwidth part and subcarrier spacing associated with one of the component carriers.

In a sixteenth aspect, alone or in combination with one or more of the first through fifteenth aspects, the current PDCCH occasion unit is anchored on a PDCCH search space associated with a downlink scheduling DCI format.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with semi-static HARQ codebooks for cross-RAT communications.

As shown in FIG. 8, in some aspects, process 800 may include receiving a configuration for a first semi-static HARQ codebook associated with a first RAT and a second semi-static HARQ codebook associated with a second RAT (block 810). For example, the UE (e.g., using reception component 1102 and/or communication manager 1106, depicted in FIG. 11) may receive a configuration for a first semi-static HARQ codebook associated with a first RAT and a second semi-static HARQ codebook associated with a second RAT, as described above.

As further shown in FIG. 8, in some aspects, process 800 may include monitoring a PDCCH across multiple component carriers in accordance with the first semi-static HARQ codebook and the second semi-static HARQ codebook (block 820). For example, the UE (e.g., using communication manager 1106, depicted in FIG. 11) may monitor a PDCCH across multiple component carriers in accordance with the first semi-static HARQ codebook and the second semi-static HARQ codebook, as described above.

Process 800 may include additional aspects, such as any single aspect or any combination of aspects described below and/or in connection with one or more other processes described elsewhere herein.

In a first aspect, monitoring the PDCCH across multiple component carriers includes monitoring a PDCCH based, at least in part, on a component carrier and radio access technology associated with one of the first semi-static HARQ codebook or the second semi-static HARQ codebook.

In a second aspect, alone or in combination with the first aspect, monitoring the PDCCH across multiple component carriers includes monitoring the PDCCH based, at least in part, on a component carrier index.

In a third aspect, alone or in combination with one or more of the first and second aspects, the first semi-static HARQ codebook is associated with a PDCCH of the first RAT and the second semi-static HARQ codebook is associated with a PDCCH of the second RAT.

In a fourth aspect, alone or in combination with one or more of the first through third aspects, the first semi-static HARQ codebook includes HARQ ACK or NACK bits for PDSCH communications associated with the first RAT and the second semi-static HARQ codebook includes HARQ ACK or NACK bits for PDSCH communications associated with the first RAT and the second RAT.

In a fifth aspect, alone or in combination with one or more of the first through fourth aspects, the first semi-static HARQ codebook includes HARQ ACK or NACK bits for PDSCH communications associated with the first RAT and the second RAT and the second semi-static HARQ codebook includes HARQ ACK or NACK bits for PDSCH communications associated with the second RAT.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with HARQ codebook for cross-RAT communications.

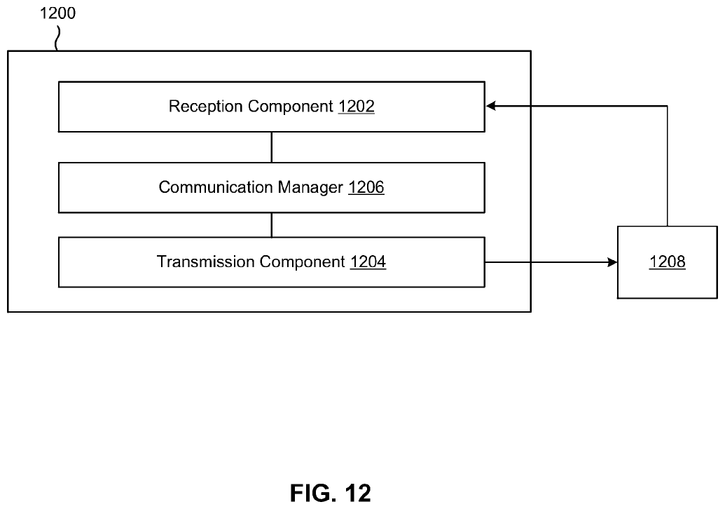

As shown in FIG. 9, in some aspects, process 900 may include transmitting a cross-RAT indication for joint or separate DAI fields via DCI for a HARQ codebook (block 910). For example, the network node (e.g., using transmission component 1204 and/or communication manager 1206, depicted in FIG. 12) may transmit a cross-RAT indication for joint or separate DAI fields via DCI for a HARQ codebook, as described above.

As further shown in FIG. 9, in some aspects, process 900 may include configuring a UE to monitor a PDCCH across multiple component carriers in accordance with the cross-RAT indication for the joint or separate DAI fields (block 920). For example, the network node (e.g., using communication manager 1206, depicted in FIG. 12) may configure a UE to monitor a PDCCH across multiple component carriers in accordance with the cross-RAT indication for the joint or separate DAI fields, as described above.

Process 900 may include additional aspects, such as any single aspect or any combination of aspects described below and/or in connection with one or more other processes described elsewhere herein.

In a first aspect, the cross-RAT indication is for separate DAI fields.

In a second aspect, alone or in combination with the first aspect, the separate DAI fields are each associated with PDCCH communications via different radio access technologies.

In a third aspect, alone or in combination with one or more of the first and second aspects, the separate DAI fields are each associated with PDSCH communications via different radio access technologies.

In a fourth aspect, alone or in combination with one or more of the first through third aspects, the separate DAI fields include C-DAI values, and only one of the C-DAI values is indicated via the DCI.

In a fifth aspect, alone or in combination with one or more of the first through fourth aspects, the separate DAI fields include T-DAI values.

In a sixth aspect, alone or in combination with one or more of the first through fifth aspects, the cross-RAT indication for the separate DAI fields includes one or more indications for T-DAI values associated with both scheduled and non-scheduled radio access technology communications.

In a seventh aspect, alone or in combination with one or more of the first through sixth aspects, the cross-RAT indication for the separate DAI fields includes one or more indications for T-DAI values associated with non-scheduled radio access technology communications.

In an eighth aspect, alone or in combination with one or more of the first through seventh aspects, the cross-RAT indication for the separate DAI fields includes one or more indications for T-DAI values associated with scheduled radio access technology communications.

In a ninth aspect, alone or in combination with one or more of the first through eighth aspects, the cross-RAT indication is for a joint DAI field.

In a tenth aspect, alone or in combination with one or more of the first through ninth aspects, configuring the UE to monitor the PDCCH across multiple component carriers includes configuring the UE to monitor a PDCCH of two or more component carriers having a same radio access technology before monitoring a PDCCH of one or more component carriers having a different radio access technology.

In an eleventh aspect, alone or in combination with one or more of the first through tenth aspects, configuring the UE to monitor the PDCCH across multiple component carriers includes configuring the UE to monitor a PDCCH of one or more component carriers in order of a component carrier index.

In a twelfth aspect, alone or in combination with one or more of the first through eleventh aspects, the multiple component carriers have different subcarrier spacings, and each of the joint or separate DAI fields includes a T-DAI value.

In a thirteenth aspect, alone or in combination with one or more of the first through twelfth aspects, process 900 includes configuring the UE to accumulate a T-DAI value across one or more of radio access technologies or component carriers.

In a fourteenth aspect, alone or in combination with one or more of the first through thirteenth aspects, configuring the UE to accumulate the T-DAI value includes configuring the UE to accumulate a total number of component carrier pairs or PDCCH occasion pairs up to a current PDCCH occasion unit.

In a fifteenth aspect, alone or in combination with one or more of the first through fourteenth aspects, the current PDCCH occasion unit is based, at least in part, on an active bandwidth part and subcarrier spacing associated with one of the component carriers.

In a sixteenth aspect, alone or in combination with one or more of the first through fifteenth aspects, the current PDCCH occasion unit is anchored on a PDCCH search space associated with a downlink scheduling DCI format.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with semi-static HARQ codebooks for cross-RAT communications.

As shown in FIG. 10, in some aspects, process 1000 may include transmitting a configuration for a first semi-static HARQ codebook associated with a first RAT and a second semi-static HARQ codebook associated with a second RAT (block 1010). For example, the network node (e.g., using transmission component 1204 and/or communication manager 1206, depicted in FIG. 12) may transmit a configuration for a first semi-static HARQ codebook associated with a first RAT and a second semi-static HARQ codebook associated with a second RAT, as described above.

As further shown in FIG. 10, in some aspects, process 1000 may include configuring a UE to monitor a PDCCH across multiple component carriers in accordance with the first semi-static HARQ codebook and the second semi-static HARQ codebook (block 1020). For example, the network node (e.g., using communication manager 1206, depicted in FIG. 12) may configure a UE to monitor a PDCCH across multiple component carriers in accordance with the first semi-static HARQ codebook and the second semi-static HARQ codebook, as described above.

Process 1000 may include additional aspects, such as any single aspect or any combination of aspects described below and/or in connection with one or more other processes described elsewhere herein.

In a first aspect, configuring the UE to monitor the PDCCH across multiple component carriers includes configuring the UE to monitor a PDCCH based, at least in part, on a component carrier and radio access technology associated with one of the first semi-static HARQ codebook or the second semi-static HARQ codebook.

In a second aspect, alone or in combination with the first aspect, configuring the UE to monitor the PDCCH across multiple component carriers includes configuring the UE to monitor the PDCCH based, at least in part, on a component carrier index.

In a third aspect, alone or in combination with one or more of the first and second aspects, the first semi-static HARQ codebook is associated with a scheduled PDSCH of the first RAT and the second semi-static HARQ codebook is associated with a scheduled PDSCH of the second RAT.

In a fourth aspect, alone or in combination with one or more of the first through third aspects, the first semi-static HARQ codebook includes HARQ ACK or NACK bits for PDSCH communications associated with the first RAT and the second semi-static HARQ codebook includes HARQ ACK or NACK bits for PDSCH communications associated with the first RAT and the second RAT.

In a fifth aspect, alone or in combination with one or more of the first through fourth aspects, the first semi-static HARQ codebook includes HARQ ACK or NACK bits for PDSCH communications associated with the first RAT and the second RAT and the second semi-static HARQ codebook includes HARQ ACK or NACK bits for PDSCH communications associated with the second RAT.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-6. Additionally, or alternatively, the apparatus 1100 may be configured to perform one or more processes described herein, such as process 700 of FIG. 7, process 800 of FIG. 8, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a cross-RAT indication for joint or separate DAI fields via DCI for a HARQ codebook. The communication manager 1106 may monitor a PDCCH across multiple component carriers in accordance with the cross-RAT indication for the joint or separate DAI fields.

The communication manager 1106 may accumulate a T-DAI value across one or more of radio access technologies or component carriers.

The reception component 1102 may receive a configuration for a first semi-static HARQ codebook associated with a first RAT and a second semi-static HARQ codebook associated with a second RAT. The communication manager 1106 may monitor a PDCCH across multiple component carriers in accordance with the first semi-static HARQ codebook and the second semi-static HARQ codebook.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-6. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a cross-RAT indication for joint or separate DAI fields via DCI for a HARQ codebook. The communication manager 1206 may configure a UE to monitor a PDCCH across multiple component carriers in accordance with the cross-RAT indication for the joint or separate DAI fields.

The communication manager 1206 may configure the UE to accumulate a T-DAI value across one or more of radio access technologies or component carriers.

The transmission component 1204 may transmit a configuration for a first semi-static HARQ codebook associated with a first RAT and a second semi-static HARQ codebook associated with a second RAT. The communication manager 1206 may configure a UE to monitor a PDCCH across multiple component carriers in accordance with the first semi-static HARQ codebook and the second semi-static HARQ codebook.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving a cross-RAT indication for joint or separate DAI fields via DCI for a HARQ codebook; and monitoring a PDCCH across multiple component carriers in accordance with the cross-RAT indication for the joint or separate DAI fields.

Aspect 2: The method of Aspect 1, wherein the cross-RAT indication is for separate DAI fields.

Aspect 3: The method of Aspect 2, wherein the separate DAI fields are each associated with PDCCH communications via different radio access technologies.

Aspect 4: The method of Aspect 2, wherein the separate DAI fields are each associated with PDSCH communications via different radio access technologies.

Aspect 5: The method of Aspect 2, wherein the separate DAI fields include C-DAI values, and wherein only one of the C-DAI values is indicated via the DCI.

Aspect 6: The method of Aspect 2, wherein the separate DAI fields include T-DAI values.

Aspect 7: The method of Aspect 6, wherein the cross-RAT indication for the separate DAI fields includes one or more indications for T-DAI values associated with both scheduled and non-scheduled radio access technology communications.

Aspect 8: The method of Aspect 6, wherein the cross-RAT indication for the separate DAI fields includes an indication for T-DAI values associated with non-scheduled radio access technology communications.

Aspect 9: The method of Aspect 6, wherein the cross-RAT indication for the separate DAI fields includes an indication for T-DAI values associated with scheduled radio access technology communications.

Aspect 10: The method of any of Aspects 1-9, wherein the cross-RAT indication is for a joint DAI field.

Aspect 11: The method of Aspect 10, wherein monitoring the PDCCH across multiple component carriers includes monitoring a PDCCH of two or more component carriers having a same radio access technology before monitoring a PDCCH of one or more component carriers having a different radio access technology.

Aspect 12: The method of Aspect 10, wherein monitoring the PDCCH across the multiple component carriers includes monitoring a PDCCH of one or more component carriers in order of a component carrier index.

Aspect 13: The method of any of Aspects 1-12, wherein the multiple component carriers have different subcarrier spacings, and wherein each of the joint or separate DAI fields includes a T-DAI value.

Aspect 14: The method of Aspect 13, further comprising accumulating a T-DAI value across one or more of radio access technologies or component carriers.

Aspect 15: The method of Aspect 14, wherein accumulating the T-DAI value includes accumulating a total number of component carrier pairs or PDCCH occasion pairs up to a current PDCCH occasion unit.

Aspect 16: The method of Aspect 15, wherein the current PDCCH occasion unit is based, at least in part, on an active bandwidth part and subcarrier spacing associated with one of the component carriers.

Aspect 17: The method of Aspect 16, wherein the current PDCCH occasion unit is anchored on a PDCCH search space associated with a downlink scheduling DCI format.

Aspect 18: A method of wireless communication performed by a UE, comprising: receiving a configuration for a first semi-static HARQ codebook associated with a first RAT and a second semi-static HARQ codebook associated with a second RAT; and monitoring a PDCCH across multiple component carriers in accordance with the first semi-static HARQ codebook and the second semi-static HARQ codebook.

Aspect 19: The method of Aspect 18, wherein monitoring the PDCCH across multiple component carriers includes monitoring a PDCCH based, at least in part, on a component carrier and radio access technology associated with one of the first semi-static HARQ codebook or the second semi-static HARQ codebook.

Aspect 20: The method of any of Aspects 18-19, wherein monitoring the PDCCH across multiple component carriers includes monitoring the PDCCH based, at least in part, on a component carrier index.

Aspect 21: The method of any of Aspects 18-20, wherein the first semi-static HARQ codebook is associated with a PDCCH of the first RAT and the second semi-static HARQ codebook is associated with a PDCCH of the second RAT.

Aspect 22: The method of Aspect 21, wherein the first semi-static HARQ codebook includes HARQ ACK or NACK bits for PDSCH communications associated with the first RAT and the second semi-static HARQ codebook includes HARQ ACK or NACK bits for PDSCH communications associated with the first RAT and the second RAT.

Aspect 23: The method of Aspect 21, wherein the first semi-static HARQ codebook includes HARQ acknowledgement or negative acknowledgement (ACK or NACK) bits for PDSCH communications associated with the first RAT and the second RAT and the second semi-static HARQ codebook includes HARQ ACK or NACK bits for PDSCH communications associated with the second RAT.

Aspect 24: A method of wireless communication performed by a network node, comprising: transmitting a cross-RAT indication for joint or separate DAI fields via DCI for a HARQ codebook; and configuring a user equipment (UE) to monitor a PDCCH across multiple component carriers in accordance with the cross-RAT indication for the joint or separate DAI fields.

Aspect 25: The method of Aspect 24, wherein the cross-RAT indication is for separate DAI fields.

Aspect 26: The method of Aspect 25, wherein the separate DAI fields are each associated with PDCCH communications via different radio access technologies.

Aspect 27: The method of Aspect 25, wherein the separate DAI fields are each associated with PDSCH communications via different radio access technologies.

Aspect 28: The method of Aspect 25, wherein the separate DAI fields include C-DAI values, and wherein only one of the C-DAI values is indicated via the DCI.

Aspect 29: The method of Aspect 25, wherein the separate DAI fields include T-DAI values.

Aspect 30: The method of Aspect 29, wherein the cross-RAT indication for the separate DAI fields includes one or more indications for T-DAI values associated with both scheduled and non-scheduled radio access technology communications.

Aspect 31: The method of Aspect 29, wherein the cross-RAT indication for the separate DAI fields includes one or more indications for T-DAI values associated with non-scheduled radio access technology communications.

Aspect 32: The method of Aspect 29, wherein the cross-RAT indication for the separate DAI fields includes one or more indications for T-DAI values associated with scheduled radio access technology communications.

Aspect 33: The method of any of Aspects 24-32, wherein the cross-RAT indication is for a joint DAI field.

Aspect 34: The method of Aspect 33, wherein configuring the UE to monitor the PDCCH across multiple component carriers includes configuring the UE to monitor a PDCCH of two or more component carriers having a same radio access technology before monitoring a PDCCH of one or more component carriers having a different radio access technology.

Aspect 35: The method of Aspect 33, wherein configuring the UE to monitor the PDCCH across multiple component carriers includes configuring the UE to monitor a PDCCH of one or more component carriers in order of a component carrier index.

Aspect 36: The method of any of Aspects 24-35, wherein the multiple component carriers have different subcarrier spacings, and wherein each of the joint or separate DAI fields includes a T-DAI value.

Aspect 37: The method of Aspect 36, further comprising configuring the UE to accumulate a T-DAI value across one or more of radio access technologies or component carriers.

Aspect 38: The method of Aspect 37, wherein configuring the UE to accumulate the T-DAI value includes configuring the UE to accumulate a total number of component carrier pairs or PDCCH occasion pairs up to a current PDCCH occasion unit.

Aspect 39: The method of Aspect 38, wherein the current PDCCH occasion unit is based, at least in part, on an active bandwidth part and subcarrier spacing associated with one of the component carriers.

Aspect 40: The method of Aspect 39, wherein the current PDCCH occasion unit is anchored on a PDCCH search space associated with a downlink scheduling DCI format.

Aspect 41: A method of wireless communication performed by a network node, comprising: transmitting a configuration for a first semi-static HARQ codebook associated with a first RAT and a second semi-static HARQ codebook associated with a second RAT; and configuring a UE to monitor a PDCCH across multiple component carriers in accordance with the first semi-static HARQ codebook and the second semi-static HARQ codebook.

Aspect 42: The method of Aspect 41, wherein configuring the UE to monitor the PDCCH across multiple component carriers includes configuring the UE to monitor a PDCCH based, at least in part, on a component carrier and radio access technology associated with one of the first semi-static HARQ codebook or the second semi-static HARQ codebook.

Aspect 43: The method of any of Aspects 41-42, wherein configuring the UE to monitor the PDCCH across multiple component carriers includes configuring the UE to monitor the PDCCH based, at least in part, on a component carrier index.

Aspect 44: The method of any of Aspects 41-43, wherein the first semi-static HARQ codebook is associated with a scheduled PDSCH of the first RAT and the second semi-static HARQ codebook is associated with a scheduled PDSCH of the second RAT.

Aspect 45: The method of Aspect 44, wherein the first semi-static HARQ codebook includes HARQ ACK or NACK bits for PDSCH communications associated with the first RAT and the second semi-static HARQ codebook includes HARQ ACK or NACK bits for PDSCH communications associated with the first RAT and the second RAT.

Aspect 46: The method of Aspect 44, wherein the first semi-static HARQ codebook includes HARQ ACK or NACK bits for PDSCH communications associated with the first RAT and the second RAT and the second semi-static HARQ codebook includes HARQ ACK or NACK bits for PDSCH communications associated with the second RAT.

Aspect 47: An apparatus for wireless communication at a device, comprising a processor; memory coupled with the processor; and instructions stored in the memory and executable by the processor to cause the apparatus to perform the method of one or more of Aspects 1-46.

Aspect 48: A device for wireless communication, comprising a memory and one or more processors coupled to the memory, the one or more processors configured to perform the method of one or more of Aspects 1-46.

Aspect 49: An apparatus for wireless communication, comprising at least one means for performing the method of one or more of Aspects 1-46.

Aspect 50: A non-transitory computer-readable medium storing code for wireless communication, the code comprising instructions executable by a processor to perform the method of one or more of Aspects 1-46.

Aspect 51: A non-transitory computer-readable medium storing a set of instructions for wireless communication, the set of instructions comprising one or more instructions that, when executed by one or more processors of a device, cause the device to perform the method of one or more of Aspects 1-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors, the one or more processors, individually or collectively and based at least in part on information stored in the one or more memories, being configured to:
receive a cross radio access technology (cross-RAT) indication for joint or separate downlink assignment index (DAI) fields via downlink control information (DCI) for a hybrid automatic repeat request (HARQ) codebook; and
monitor a physical downlink control channel (PDCCH) across multiple component carriers in accordance with the cross-RAT indication for the joint or separate DAI fields.

2. The apparatus of claim 1, wherein the cross-RAT indication is for separate DAI fields.

3. The apparatus of claim 2, wherein the separate DAI fields are each associated with PDCCH communications via different radio access technologies.

4. The apparatus of claim 2, wherein the separate DAI fields are each associated with physical downlink shared channel (PDSCH) communications via different radio access technologies.

5. The apparatus of claim 2, wherein the separate DAI fields include counter DAI (C-DAI) values, and wherein only one of the C-DAI values is indicated via the DCI.

6. The apparatus of claim 2, wherein the separate DAI fields include total DAI (T-DAI) values.

7. The apparatus of claim 6, wherein the cross-RAT indication for the separate DAI fields includes one or more indications for T-DAI values associated with both scheduled and non-scheduled radio access technology communications.

8. The apparatus of claim 6, wherein the cross-RAT indication for the separate DAI fields includes an indication for T-DAI values associated with non-scheduled radio access technology communications.

9. The apparatus of claim 6, wherein the cross-RAT indication for the separate DAI fields includes an indication for T-DAI values associated with scheduled radio access technology communications.

10. The apparatus of claim 1, wherein the cross-RAT indication is for a joint DAI field.

11. The apparatus of claim 10, wherein the one or more processors, to monitor the PDCCH across multiple component carriers, are configured to monitor a PDCCH of two or more component carriers having a same radio access technology before monitoring a PDCCH of one or more component carriers having a different radio access technology.

12. The apparatus of claim 10, wherein the one or more processors, to monitor the PDCCH across the multiple component carriers, are configured to monitor a PDCCH of one or more component carriers in order of a component carrier index.

13. The apparatus of claim 1, wherein the multiple component carriers have different subcarrier spacings, and wherein each of the joint or separate DAI fields includes a total DAI (T-DAI) value.

14. The apparatus of claim 13, wherein the one or more processors are further configured to accumulate a total DAI (T-DAI) value across one or more of radio access technologies or component carriers.

15. The apparatus of claim 14, wherein the one or more processors, to accumulate the T-DAI value, are configured to accumulate a total number of component carrier pairs or PDCCH occasion pairs up to a current PDCCH occasion unit.

16. The apparatus of claim 15, wherein the current PDCCH occasion unit is based, at least in part, on an active bandwidth part and subcarrier spacing associated with one of the component carriers.

17. The apparatus of claim 16, wherein the current PDCCH occasion unit is anchored on a PDCCH search space associated with a downlink scheduling DCI format.

18. An apparatus for wireless communication at a UE, comprising:
one or more memories; and
one or more processors, the one or more processors, individually or collectively and based at least in part on information stored in the one or more memories, being configured to:
receive a configuration for a first semi-static hybrid automatic repeat request (HARQ) codebook associated with a first radio access technology (RAT) and a second semi-static HARQ codebook associated with a second RAT; and
monitor a physical downlink control channel (PDCCH) across multiple component carriers in accordance with the first semi-static HARQ codebook and the second semi-static HARQ codebook.

19. The apparatus of claim 18, wherein the one or more processors, to monitor the PDCCH across multiple component carriers, are configured to monitor a PDCCH based, at least in part, on a component carrier and radio access technology associated with one of the first semi-static HARQ codebook or the second semi-static HARQ codebook.

20. The apparatus of claim 18, wherein the one or more processors, to monitor the PDCCH across multiple component carriers, are configured to monitor the PDCCH based, at least in part, on a component carrier index.

21-30. (canceled)
